(19) United States
(12) Patent Application Publication
(10) Pub. No.: US 2016/0049876 A1
(43) Pub. Date: Feb. 18, 2016

(54) SINGLE PACKAGE SYNCHRONOUS RECTIFIER

(71) Applicant: Alpha and Omega Semiconductor Incorporated, Sunnyvale, CA (US)

(72) Inventors: Gilbert Lee, Saratoga, CA (US); James Park, Seoul (KR); Xiaotian Zhang, San Jose, CA (US); Benjamin Pun, Santa Clara, CA (US); Yu Ding, Shanghai (CN); Alex Kim, Seoul (KR); Wayne F. Eng, Danville, CA (US); Kuang Ming Chang, Fremont, CA (US); Xiaobin Wang, San Jose, CA (US)

(21) Appl. No.: 14/458,104

(22) Filed: Aug. 12, 2014

(51) Int. Cl. H02M 3/335

(52) U.S. Cl. CPC H02M 3/335

(57) ABSTRACT

A synchronous rectifier comprising a discrete switching device and a controller for controlling the discrete switching device both mounted on a common die pad and packaged in a single package. The packaging of the discrete switching device and the controller together in a single package provides shortest path of connection between the ports of the controller and the switching device, enabling the controller to accurately sense voltage across the switching device thereby avoiding the effect of parasitic inductances and enabling the controller to enable/disable the switching device at the precise time, resulting in improved power consumption and better efficiency.

### FIELD OF DISCLOSURE

The present disclosure relates to synchronous rectifiers used in power supplies.

### DEFINITIONS

The expression “package” used in the context of this disclosure refers to a semiconductor package used for encasing semiconductor wafers and/or electronic components therein.

The expression “die pad” used in the context of this disclosure refers to a die paddle on which a semiconductor die/wafer is mounted, in a semiconductor package.

These definitions are in addition to those expressed in the art.

### BACKGROUND

Electronic devices such as televisions (TV), personal computers (PC), and the like that operate within certain power supply limits are provided with regulated power supplies that provide the necessary clean, regulated power to the electronic device for efficient working of the device. A regulated power supply converts AC to DC or DC to DC and further rectifies the converted DC to provide a stable voltage to different circuits in the electronic device. With advancement in technologies, electronic devices are being equipped to perform multiple functions from communication to automation. Consequently there is ever-increasing demand for power supplies with multiple functions such as lower input and output voltages, higher currents, faster transient response, and the like. To meet these demands, synchronous rectification is adopted in regulated power supplies.

A commonly used power supply in electronic devices is Switched Mode Power Supply (SMPS). An SMPS transfers power from a source such as mains electrical power, to a load such as an electronic device including TV, PC, and the like. SMPS is typically divided in two parts referred to as a primary side which is connected to the mains electrical power and a secondary side which is connected to the load. The mains electrical AC input or DC input is converted to different level of DC by a transformer and further rectified by a switching regulator/rectifier included in the secondary side of the SMPS. Rectification of DC voltage in the secondary side is achieved by asynchronous rectification also referred to as passive rectification or synchronous rectification also referred to as active rectification. Passive devices/switches are used for performing asynchronous rectification and active devices/switches are used for performing synchronous rectification.

Asynchronous rectifiers typically include diodes, referred to as passive devices/switches, which cannot be synchronized by the controller, and the rectification is referred to as asynchronous rectification due to the inherent property of diodes to conduct current as a result of rising forward voltage across the diode, typically referred to as forward bias mode. However, the forward conduction loss of diode rectifiers contributes significantly to the overall power loss in the power supply. Schottky diodes are increasingly used for better performance and efficiency. Schottky diodes have smaller drop-out voltage compared to conventional diodes resulting in fast operation and small power loss. However, schottky diodes have lower breakdown voltages compared to conventional diodes and are also expensive. Furthermore, a heavy load drawing excessive power will considerably increase the temperature of the schottky diode leading to the requirement of a bigger heat sink to dissipate the heat.

MOSFETs are referred to as active switches, which can be synchronized by the controller, and the rectification is referred to as synchronous rectification as the conduction of current through the MOSFET is controlled by a control circuit or an integrated circuit (IC). Synchronous rectifiers typically consist of an active switch, generally a MOSFET, and its external controller that turns the MOSFET ON/OFF by sensing the voltage across the MOSFET. However, the use of an external controller necessitates the controller to be placed at a predetermined distance from the MOSFET on a printed circuit board (PCB), whereby the parasitic inductances in the MOSFET as well as along the power lines on the PCB cause inaccurate sensing of voltage across the MOSFET. As a result, the controller incorrectly turns ON/OFF the MOSFET resulting in reduction in the ON time of the MOSFET, leading to power loss.

Hence there is a need to alleviate the drawbacks associated with sensing of voltage in synchronous rectifiers and achieve effective rectification of power to provide clean, regulated power to electronic devices for efficient working of the electronic devices.

### Objects

Some of the objects of the present disclosure aimed to ameliorate one or more problems of the prior art or to at least provide a useful alternative are listed herein below.

An object of the present disclosure is to provide a synchronous rectifier that accurately senses voltage.

Another object of the present disclosure is to provide a synchronous rectifier that enhances thermal performance of power supplies.

Another object of the present disclosure is to provide a synchronous rectifier that facilitates clean, regulated power from power supplies.

Another object of the present disclosure is to provide a synchronous rectifier that increases the efficiency of power supplies.

Another object of the present disclosure is to provide a synchronous rectifier that enhances the power density of power supplies.

Another object of the present disclosure is to provide a synchronous rectifier that reduces the BOM.

Another object of the present disclosure is to provide a synchronous rectifier having single as well dual channels packaged in a single package.

Another object of the present disclosure is to provide an interface that reduces the overall costs of power supplies.

Other objects and advantages of the present disclosure will be more apparent from the following description when read in conjunction with the accompanying Figures, which are not intended to limit the scope of the present disclosure.

### SUMMARY

A synchronous rectifier comprising at least one discrete switching device and at least one controller adapted to sense voltage across the switching device and enable/disable the switching device based on the sensed voltage, characterized in that the discrete switching device and the controller are mounted on a common die pad and packaged in a single package.

Generally, the discrete switching device is selected from the group consisting of Bipolar Junction Transistor (BJT), Metal Oxide Semiconductor Field Effect Transistor (MOSFET), Insulated Gate Bipolar Transistor (IGBT) and Silicon Controlled Rectifier (SCR).

Typically, at least one terminal of the discrete switching device is soldered on the common die pad.

Typically, the terminal is a drain of a MOSFET, the MOSFET having bottom drain, a top source and a top gate.

Additionally, the package comprises a ground lead and the source of the MOSFET is connected to the ground lead by a plurality of bonding wires or metal leads.

Additionally, the controller comprises a ground port and the source of the MOSFET is connected to the ground port by a plurality of bonding wires. Additionally, the controller comprises a gate driving port and the gate of the MOSFET is connected to the gate driving port by at least one bonding wire.

Additionally, the controller comprises a voltage sensing port, the voltage sensing port connected to the common die pad by a down bond or to the bottom drain of the MOSFET by a bonding wire.

Additionally, the package comprises a middle lead connected to the common die pad, the voltage sensing port connected to the middle lead by a bonding wire.

Typically, the controller is attached to the common die pad using at least one layer of non-conductive material to electrically isolate the controller from the common die pad.

Typically, the package includes a lead frame having the common die pad, the lead frame partially plated with at least one of silver and nickel.

Generally, the package is selected from the group consisting of TO220, TO220F, TO252(DPAK) and TO263(D2PAK).

Additionally, the MOSFET is a dual drain MOSFET having a top gate, a top source, a bottom drain and a top drain, that both drains are connected each other electrically.

Typically, the voltage sensing port is connected to the top drain of the dual drain MOSFET by a bonding wire.

A two channel synchronous rectifier comprising:
a first pair of a first discrete switching device and a first controller adapted to sense voltage across the first discrete switching device and enable/disable the first discrete switching device based on the sensed voltage across the first discrete switching device;
a second pair of a second discrete switching device and a second controller adapted to sense voltage across the second discrete switching device and enable/disable the second discrete switching device based on the sensed voltage across the second discrete switching device;

the first pair mounted on a first die pad and the second pair mounted on a second die pad and packaged in a single package, wherein the first and the second die pads are electrically isolated from each other.

Generally, each of the first discrete switching device and the second discrete switching device is selected from the group consisting of Bipolar Junction Transistor (BJT), Metal Oxide Semiconductor Field Effect Transistor (MOSFET), Insulated Gate Bipolar Transistor (IGBT) and Silicon Controlled Rectifier (SCR).

Typically,
at least one terminal of the first discrete switching device is soldered on the first die pad; and
at least one terminal of the second discrete switching device is soldered on the second die pad.

Typically,
the terminal of the first switching device is a drain of a first MOSFET; and
the terminal of the second switching device is a drain of a second MOSFET;
   each of the first and second MOSFETs having bottom drain, a top source and a top gate.

Additionally, the package comprises a common ground lead and the source of the first MOSFET and the source of the second MOSFET are connected to the common ground lead by a plurality of-bonding wires or a metal clip.

Additionally,
the first controller comprises a first ground port and the source of the first MOSFET is connected to the first ground port by a plurality of bonding wires or a metal clip; and
the second controller comprises a second ground port the source of the second MOSFET is connected to the second ground port by a plurality of bonding wires or a metal clip.

Additionally,
the first controller comprises a first gate driving port and the gate of the first MOSFET is connected to the first gate driving port by a bonding wire; and
the second controller comprises a second gate driving port and the gate of the second MOSFET is connected to the second gate driving port, by a bonding wire.

Additionally,
the first controller comprises a first voltage sensing port, the first voltage sensing port connected to the first die pad by a down bond or to the bottom drain of the first MOSFET by a bonding wire; and
the second controller comprises a second voltage sensing port, the second voltage sensing port connected to the second die pad by a down bond or to the bottom drain of the second MOSFET by a bonding wire.

Additionally,
the package comprises a first sensing lead connected to the first die pad, the voltage sensing terminal connected to the first sensing lead by a bonding wire; and
the package comprises a second sensing lead connected to the second die pad, the voltage sensing terminal connected to the second sensing lead by a bonding wire.

Typically,
the first controller is attached to the first die pad using at least one layer of non-conductive material to electrically isolate the first controller from the first die pad; and
the second controller is attached to the second die pad using at least one layer of non-conductive material to electrically isolate the second controller from the second die pad.

Typically, the package comprises a first lead frame having the first die pad and a second lead frame having the second die pad, the first and second lead frames are electrically isolated from each other, and the first and second lead frames are partially plated with at least one of silver and nickel.

Generally, the package is selected from the group consisting of TO220, TO220F and TO263 (D2PAK).

Additionally, each of the first and second MOSFETs is a dual drain MOSFET having a top gate, a top source, a bottom drain and a top drain that both drains are connected each other electrically.

Typically,
the first voltage sensing port is connected to the top drain of the first dual drain MOSFET by a bonding wire; and
the second voltage sensing port is connected to the top drain of the second dual drain MOSFET by a bonding wire.

### BRIEF DESCRIPTION OF ACCOMPANYING DRAWINGS

The interface of the present disclosure will now be described with the help of the accompanying drawings, in which:

FIG. 1A illustrates a conventional synchronous rectifier used in an SMPS having flyback converter configuration;

FIG. 1B illustrates a conventional synchronous rectifier used in an SMPS having LLC resonant (inductor-inductor-capacitor) converter configuration;

FIG. 2 illustrates the effect of parasitic inductances associated with conventional synchronous rectifiers;

FIGS. 3A-3B illustrate a graphical representation depicting the rectification achieved by the conventional synchronous rectifier of FIG. 1A;

FIGS. 3C-3D illustrates a graphical representation depicting the rectification achieved by the conventional synchronous rectifier of FIG. 1B;

FIG. 4 illustrates a synchronous rectifier in accordance with an embodiment of the present disclosure;

FIG. 5 illustrates a synchronous rectifier in accordance with another embodiment of the present disclosure;

FIG. 6A illustrates the synchronous rectifier of FIG. 4 used in an SMPS having flyback converter configuration;

FIG. 6B illustrates two synchronous rectifiers of FIG. 4 used in an SMPS having LLC resonant converter configuration;

FIG. 6C illustrates the synchronous rectifier of FIG. 4 used in an SMPS having LLC resonant converter configuration;

FIG. 7 illustrates the alleviation of the effect of parasitic inductances achieved by the synchronous rectifier of the present disclosure;

FIGS. 8A-8B illustrate a graphical representation depicting the rectification achieved by the synchronous rectifier used in the SMPS having flyback converter configuration of FIG. 6A;

FIGS. 8C-8D illustrate a graphical representation depicting the rectification achieved by the synchronous rectifier used in the SMPS having LLC resonant converter configuration of FIG. 6B;

FIGS. 9A-9C illustrate schematic diagrams of the synchronous rectifier of FIG. 4 fabricated in TO220, TO220F, TO252(DPAK) and TO263(D2PAK) semiconductor packages;

FIGS. 10A-10B illustrate schematic diagrams of the synchronous rectifier of FIG. 5 fabricated in split TO220, split TO220F and split TO263(D2PAK) semiconductor packages;

FIGS. 11A-11B illustrate a conventional MOSFET configuration;

FIGS. 12A-12B illustrate a dual drain MOSFET configuration in accordance with an embodiment of the present disclosure;

FIG. 13 illustrates a synchronous rectifier in accordance with another embodiment of the present disclosure;

FIGS. 14A-14C illustrate schematic diagrams of the synchronous rectifier of FIG. 13 fabricated in TO220F, TO252(DPAK) and TO263(D2PAK); and

FIGS. 15A-15B illustrate schematic diagrams of a synchronous rectifier of FIG. 13 having two channels, fabricated in split TO220F and split TO263(D2PAK) semiconductor packages.

### DETAILED DESCRIPTION

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

The use of the expression “at least” or “at least one” suggests the use of one or more elements or ingredients or quantities, as the use may be in the embodiment of the invention to achieve one or more of the desired objects or results.

An SMPS is typically divided in two parts referred to as a primary side which is connected to the mains electrical power and a secondary side which is connected to the load. The mains electrical AC input is converted to DC by a transformer and further rectified by a switching regulator/rectifier included in the secondary side of the SMPS.

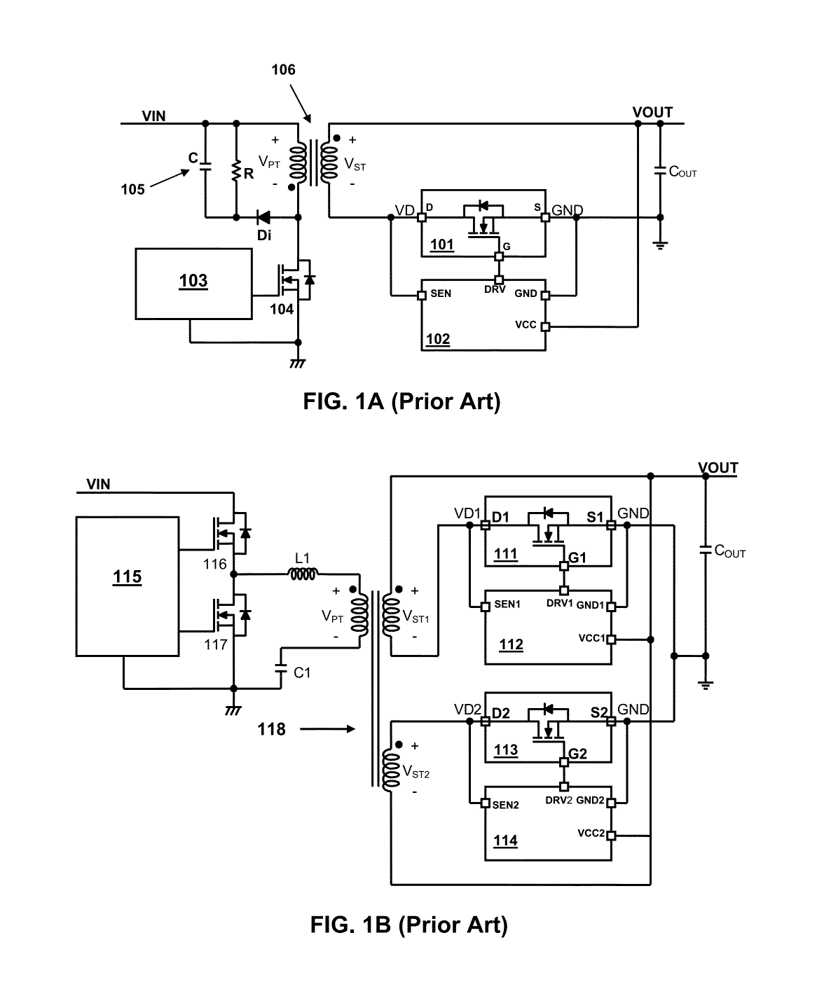

Referring to FIG. 1A, a conventional synchronous rectifier used in an SMPS having flyback converter configuration is illustrated. The flyback converter configuration includes a flyback controller 103, an active switch/MOSFET 104 and a snubber circuit 105 consisting of a resistor (R), capacitor (C) and a diode (Dᵢ) in the primary side; and a synchronous rectifier including a switch/MOSFET 101 and a controller 102 for the switch 101, and an output capacitor (Cₒᵤₜ) in the secondary side. The controller 102 includes a voltage sensing terminal (SEN), a gate driving terminal (DRV), a ground terminal (GND) and a power supply terminal (V_{cc}). The voltage sensing terminal (SEN) is connected to a drain terminal (D) of the MOSFET 101, the gate driving terminal (DRV) is connected to a gate terminal (G) of the MOSFET 101 and the ground terminal (GND) is connected to a source terminal (S) of the MOSFET 101 which is further connected to system ground. The primary voltage of the transformer 106 is denoted by V_{PT} and the secondary voltage of the transformer 106 is denoted by V_{ST}. The AC or DC input voltage (Vᵢₙ) in the primary side is converted into DC or different level DC by a transformer 106 and further rectified by the synchronous rectifier in the secondary side to provide a regulated DC output (Vₒᵤₜ).

When the secondary voltage (V_{ST}) of the transformer 106 is positive, the inherent body diode across the source terminal (S) and the drain terminal (D) of the MOSFET 101 gets forward biased to turn ON the body diode and as a result the drain voltage (V_{D}) of the MOSFET 101 goes below ground. The controller 102 then triggers the gate terminal (G) to turn ON the switch 101 whereby current (I_{S}) starts flowing in the secondary side. During the ON time of the MOSFET 101, the voltage across the drain terminal (D) and the source terminal (S) of the MOSFET 101, also referred to as drop-out voltage (V_{DS}), depends on the ON-resistance (R_{DS}ON) of the MOSFET 101 and the current (I_{S}) level, V_{DS}=R_{DS}ON*I_{S}.

When the secondary voltage (V_{ST}) of the transformer 106 reaches near ground, the controller 102 turns OFF the switch 101 and current (I_{S}) stops flowing. Furthermore, when the secondary voltage (V_{S}) is higher than OV, the controller 102 continues to keep the switch 101 turned-OFF.

Referring to FIG. 1B, a conventional synchronous rectifier used in an SMPS having LLC resonant (inductor-inductor-capacitor) converter configuration is illustrated. The LLC resonant converter configuration includes an LLC resonant controller 115, two switches/MOSFETs 116 and 117 forming an half-bridge, an inductor (L) and a capacitor (C) in the primary side; and a first synchronous rectifier including a switch/MOSFET 111 and a controller 112 for the switch 111, a second synchronous rectifier including a switch/MOSFET 113 and a controller 114 for the switch 113, and an output capacitor (Cₒᵤₜ) in the secondary side.

The controller 112 of the first synchronous rectifier includes a voltage sensing terminal (SEN₁), a gate driving terminal (DRV₁), a ground terminal (GND₁) and a power terminal (V_{cc1}). The voltage sensing terminal (SEN₁) is connected to a drain terminal (D₁) of the MOSFET 111, the gate driving terminal (DRV₁) is connected to a gate terminal (G₁) of the MOSFET 111 and the ground terminal (GND₁) is connected to a source terminal (S₁) of the MOSFET 111 which is further connected to system ground. The controller 112 senses voltage (V_{SEN1}) through the voltage sensing terminal (SEN₁) connected to the drain terminal (D₁) of the MOSFET 111, while the ground reference is available to the controller 112 through connection of the ground terminal (GND₁) to the source terminal (S₁) of the MOSFET 111.

The controller 114 of the second synchronous rectifier includes a voltage sensing terminal (SEN₂), a gate driving terminal (DRV₂), a ground terminal (GND₂) and a power terminal (V_{cc2}). The voltage sensing terminal (SEN₂) is connected to a drain terminal (D₂) of the MOSFET 113, the gate driving terminal (DRV₂) is connected to a gate terminal (G₂) of the MOSFET 113 and the ground terminal (GND₂) is connected to a source terminal (S₂) of the MOSFET 113 which is further connected to system ground. The primary voltage of the transformer 118 is denoted by V_{PT} and the secondary voltage of the transformer 118 is denoted by V_{ST1} and V_{ST2}. The controller 114 senses voltage (V_{SEN2}) through the voltage sensing terminal (SEN₂) connected to the drain terminal (D₂) of the MOSFET 113, while the ground reference is available to the controller 114 through connection of the ground terminal (GND₂) to the source terminal (S₂) of the MOSFET 113. The higher level of DC input voltage (Vᵢₙ) in the primary side is converted into lower level of DC by a transformer 118 and further rectified by the first and second synchronous rectifier's in the secondary side to provide a regulated DC output (Vₒᵤₜ).

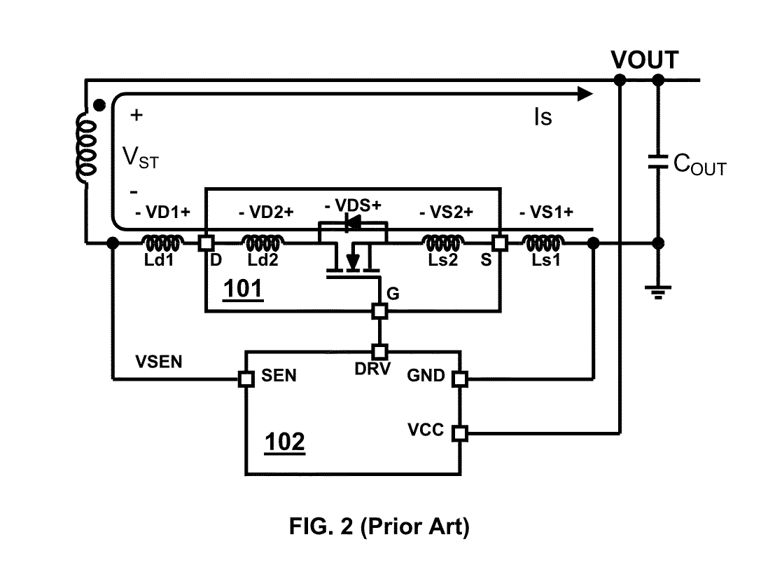

Referring to FIG. 2, the effect of parasitic inductances associated with conventional synchronous rectifiers is illustrated. Bonding wires within the MOSFET package give rise to parasitic inductances within the package, such as parasitic inductance (L_{D2}) along the drain (D) bonding wire and parasitic inductance (L_{S2}) along the source (S) bonding wire within the MOSFET package. The parasitic inductances due to bonding wires within the package are dependent on the wire length, width, thickness and material and are unavoidable due to the necessity of a minimum physical distance required between semiconductor die and package. Furthermore, the use of controller 102 external to the MOSFET 101 necessitates the controller 102 to be placed at a predetermined distance from the MOSFET on a printed circuit board (PCB), giving rise to parasitic inductances along the traces on the PCB between the sensing points of the controller 102 and the drain and source of the MOSFET 101, such as parasitic inductance (L_{D1}) along the trace between the drain terminal (D) and the voltage sensing terminal (SEN), and parasitic inductance (L_{S1}) along the trace between source terminal (S) and the ground terminal (GND), on the PCB.

The controller 102 senses the voltage across the MOSFET 101 between the drain (D) and the source (S) terminals of the MOSFET 101 to turn the MOSFET ON/OFF based on the sensed voltage. The controller 102 senses voltage (V_{SEN}) through the voltage sensing terminal (SEN) connected to the drain (D) terminal of the MOSFET 101, while the ground reference is available to the controller 102 through connection of the ground terminal (GND) to the source terminal (S) of the MOSFET 101. However, the parasitic inductances (L_{D1}, L_{D2}, L_{S1}, L_{S2}) cause inaccurate sensing of voltage across the MOSFET 101. The parasitic inductances (L_{D1}, L_{D2}, L_{S1}, L_{S2}) induce a parasitic voltage drop (V_{off}) in addition to the pure drain-to-source voltage (V_{DS}) resulting in inaccurate sensing of the voltage (V_{SEN}) which can be calculated as:

V_{SEN}=−V_{DS}−(L_{D1}+L_{D2}+L_{S1}+Ls₂)*d(I_{S})/dt,

thus V_{SEN}=−V_{DS}+V_{off}, wherein V_{off}=−(L_{D1}+L_{D2}+L_{S1}+L_{S2})*d(I_{S})/dt.

When the current (I_{S}) in the secondary side is decreasing, the positive value of the parasitic voltage drop (V_{off}) causes the voltage (V_{SEN}) to be higher than the actual drain-to-source voltage (V_{DS}). This increased sensed voltage (V_{SEN}) causes the controller 102 to incorrectly turn OFF the MOSFET 101 earlier resulting in reduction in the ON time of the MOSFET. The reduced ON time of the MOSFET results increased average drop-out voltage of the MOSFET 101. Although the inherent body diode of the MOSFET 101 turns ON, as explained herein above, during the MOSFET 101 OFF period, the increased average drop-out voltage due to forward voltage drop of the body diode leads to heavy power loss.

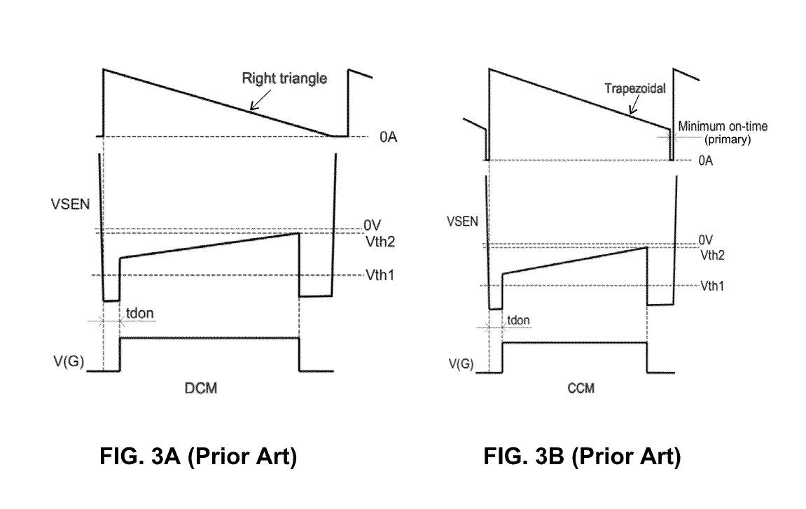

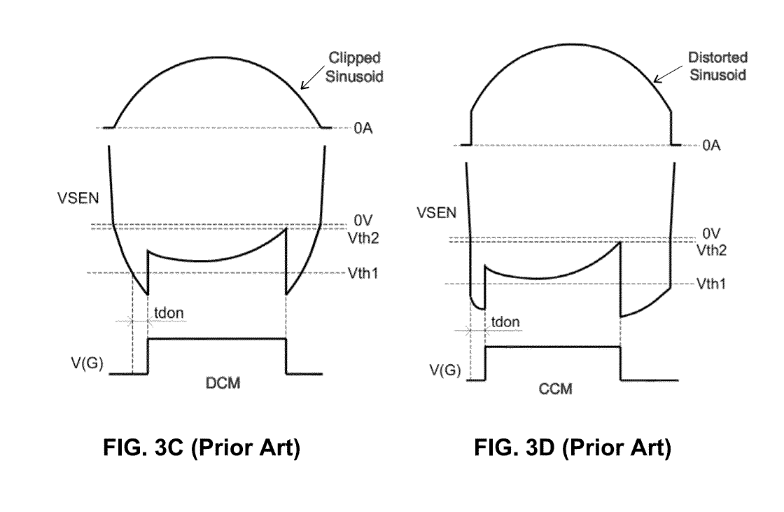

Referring to FIGS. 3A-3B, waveforms depicting the rectification achieved by the conventional synchronous rectifier of FIG. 1A are illustrated. The flyback converter operates in discontinuous conduction mode (DCM) wherein current flow in the secondary side of the converter is blocked intermittently and in continuous conduction mode (CCM) wherein the current in the secondary side of the converter flows continuously without being interrupted by turning OFF of the MOSFET 101. As illustrated in FIGS. 3A-3B, the current (I_{S}) waveform in the secondary side of the flyback converter appears as a right angled triangle in DCM operation and as a trapezoid in CCM operation. When the primary side MOSFET 104 turns OFF, current (I_{S}) starts flowing abruptly and the forward biasing of inherent body diode of the MOSFET 101 of the synchronous rectifier makes the value of sensed voltage (V_{SEN}) negative. When the sensed voltage (V_{SEN}) is lower than a first threshold voltage Vₜₕ₁, the controller 102 turns ON the MOSFET 101 after a time delay (t_{dON}). The parasitic voltage drop (V_{off}) during the ON period of the MOSFET 101 can be calculated as:

V_{off}=−(L_{D1}+L_{D2}+L_{S1}+L_{S2})*d(I_{S})/dt,

wherein V_{off} is positive in value due to negative value of d(I_{S})/dt.

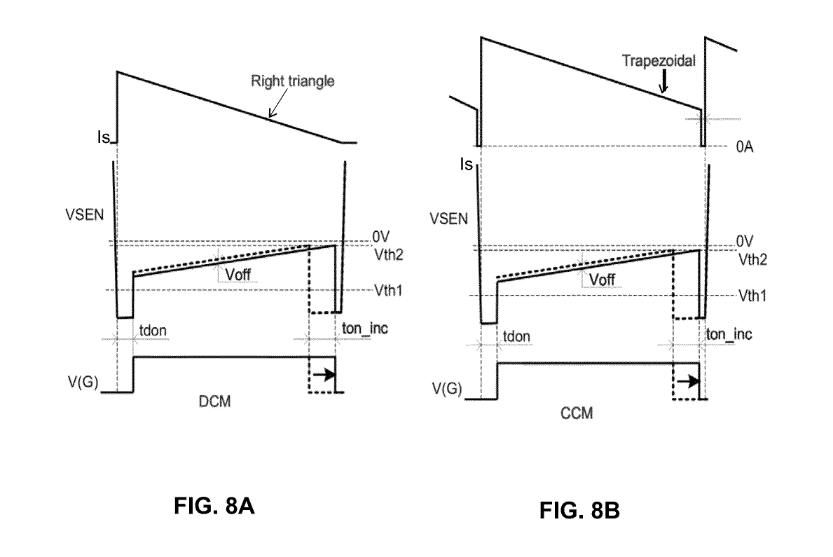

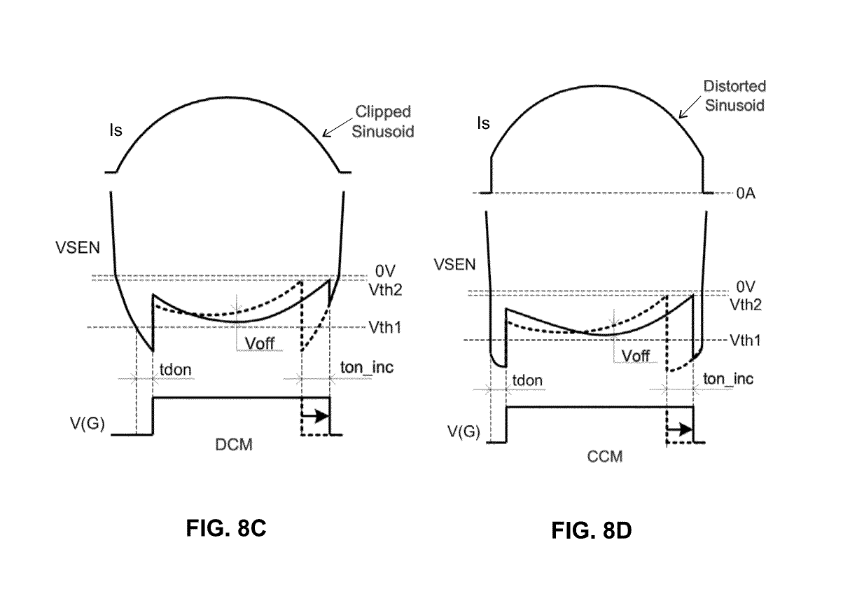

When the sensed voltage (V_{SEN}) reaches a second threshold voltage Vₜₕ₂, the controller 102 turns OFF the MOSFET 101. However, the presence of parasitic voltage drop (V_{off}) causes sensed voltage (V_{SEN}) to be higher than actual level by V_{off}, whereby the controller 102 incorrectly turns OFF the MOSFET 101 earlier. This is illustrated in FIGS. 8A-8B wherein the sensed voltage (V_{SEN}) follows the dashed line instead of following solid line, thereby causing the controller 102 to incorrectly turn OFF the MOSFET 101 earlier by time t_{ON}_{_{—}}_{inc} leading to power loss.

Referring to FIGS. 3C-3D, waveforms depicting the rectification achieved by the conventional synchronous rectifier of FIG. 1B are illustrated. Typically, the LLC resonant converter operates in boundary conduction mode (BCM) by varying frequency. However, for light loads the LLC resonant converter operates in discontinuous conduction mode (DCM) wherein current flow in the secondary side of the converter is blocked intermittently and for heavy loads, the LLC resonant converter operates in continuous conduction mode (CCM) wherein the current in the secondary side of the converter flows continuously without being interrupted by turning OFF of the MOSFETs 111 and 113. As illustrated in FIGS. 3C-3D, the current (I_{S}) waveform in the secondary side of the LLC resonant converter appears as a clipped sinusoid in DCM operation and as a distorted sinusoid in CCM operation. The secondary side MOSFET 111 gets trigged when the primary side MOSFET 116 is turned ON and the secondary side MOSFET 113 gets trigged when the primary side MOSFET 117 is turned ON. When one of the primary side MOSFETs 116 and 117 turns OFF, current (I_{S}) starts flowing smoothly and the forward biasing of inherent body diode of the MOSFETs 111 and 113 of the first and second synchronous rectifiers make the value of sensed voltage (V_{SEN1}, V_{SEN2}) negative. When the sensed voltages (V_{SEN1}, V_{SEN2}) are lower than a first threshold voltage Vₜₕ₁, the controllers 112 and 114 turn ON the MOSFETs 111 and 113 respectively after a time delay (t_{dON}). The parasitic voltage drop (V_{off}) during the ON period of the MOSFETs 111 and 113 can be calculated as:

V_{off}(t)=−(L_{D1}+L_{D2}+L_{S1}+L_{S2})*d(I_{S})/dt,

wherein sinusoid waveform of I_{S} denoted by I_{S}*sin(wt), causes V_{off}(t) to have cosine waveform denoted by -(L_{D1}+L_{D2}+L_{S1}+L_{S2})*I_{S}*w*cosin(wt).

When the sensed voltages (V_{SEN1}, V_{SEN2}) reach a second threshold voltage Vₜₕ₂, the controllers 112 and 114 turn OFF the MOSFETs 111 and 113 respectively. However, the presence of parasitic voltage drop (V_{off} (t)) causes sensed voltages (V_{SEN1}, V_{SEN2}) to be higher than actual level by V_{off} (t), whereby the controllers 112 and 114 incorrectly turn OFF the MOSFETs 111 and 113 earlier. This is illustrated in FIGS. 8C-8D wherein the sensed voltages (V_{SEN1}, V_{SEN2}) follow the dashed line instead of following solid line, thereby causing the controllers 112 and 113 to incorrectly turn OFF the MOSFETs 111 and 113 earlier by time t_{ON}_{_{—}}_{inc} leading to power loss.

Thus to overcome these aforementioned limitations, the present disclosure envisages a synchronous rectifier that can accurately sense pure drain-to-source voltage across a MOSFET to avoid power loss due to abnormal voltage sense.

The synchronous rectifier of the present disclosure will now be described with reference to the embodiments shown in the accompanying drawings. The embodiments do not limit the scope and ambit of the disclosure. The description relates purely to the examples and preferred embodiments of the disclosed pulsation dampening assembly and its suggested applications.

The embodiments herein and the various features and advantageous details thereof are explained with reference to the non-limiting embodiments in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

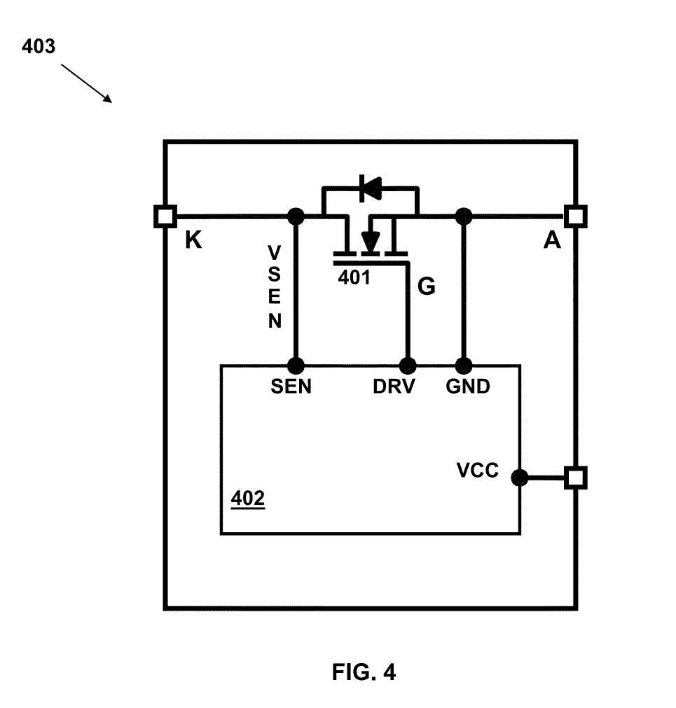

Referring to FIG. 4, a synchronous rectifier 403 in accordance with an embodiment of the present disclosure is illustrated. The rectifier 403 comprises a discrete switching device 401 and a controller 402 packaged in a single package. The discrete switching device includes but is not limited to Bipolar Junction Transistor (BJT), Metal Oxide Semiconductor Field Effect Transistor (MOSFET), Insulated Gate Bipolar Transistor (IGBT) and Silicon Controlled Rectifier (SCR). The synchronous rectifier 403 of the present disclosure is explained hereinafter with reference to a MOSFET as the switching device purely for ease of explanation. The switching device is not intended to be limited to the MOSFET, which is to be understood as illustrative only and not as limiting, as various switching devices as mentioned herein above can be used in the synchronous rectifier of the present disclosure, all falling within the scope of the present disclosure. The drain terminal of the package is denoted by K (Cathode), the source terminal of the package is denoted by A (Anode) and the power supply terminal of the package is denoted by V_{cc} which supplies power to the controller 402. The controller 402 senses voltage across the MOSFET 401 and enables/disables the MOSFET 401 based on the sensed voltage. The controller 402 comprises a voltage sensing port (SEN), a gate driving port (DRV), a ground port (GND) and a power port (V_{cc}). The voltage sensing port (SEN) is connected directly to a drain (D) of the MOSFET 401, the gate driving port (DRV) is connected directly to a gate (G) of the MOSFET 401 and the ground port (GND) is connected directly to a source (S) of the MOSFET 401 which is typically further connected to system ground through A.

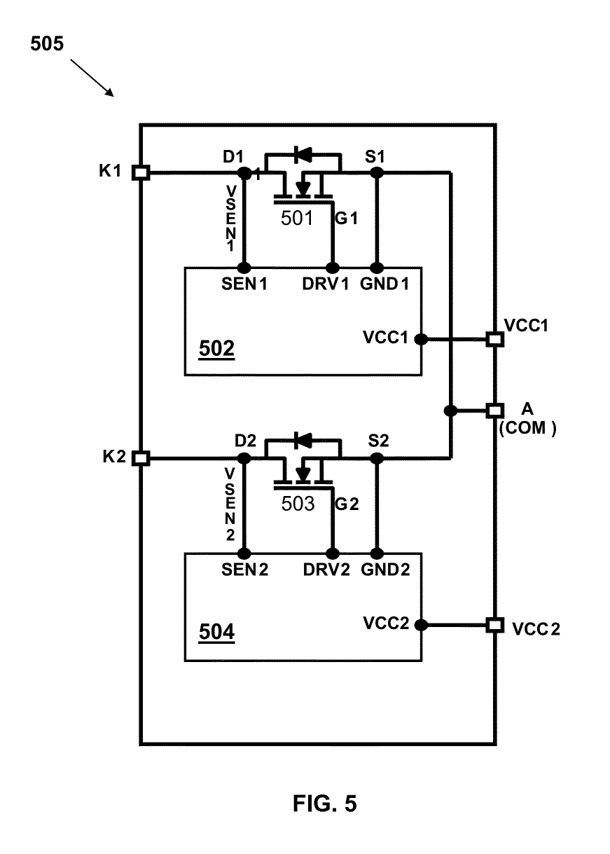

Referring to FIG. 5, a two channel synchronous rectifier 505 in accordance with another embodiment of the present disclosure is illustrated. The rectifier comprises a first pair of a first discrete switching device/MOSFET 501 and a first controller 502 and a second pair of a second discrete switching device/MOSFET 503 and a second controller 504 packaged in a single package to provide a two channel synchronous rectifier. The first and second controllers 502 and 504 sense voltage across the first and second MOSFETs 501 and 503 respectively and enable/disable the first and second MOSFETs 501 and 503 respectively based on the sensed voltage. The drain terminal of the first channel of the package is denoted by K₁, the source terminal of the first channel of the package is denoted by A and the power terminal of the first channel of the package is denoted by V_{cc1}; and the drain terminal of the first channel of the package is denoted by K₂, the source terminal of the first channel of the package is denoted by A and the power terminal of the first channel of the package is denoted by V_{cc2}. V_{cc1} and V_{cc2} are connected to the output port Vₒᵤₜ of the LLC resonant converter externally on the PCB.

The first controller 502 of the first pair comprises a first voltage sensing port (SEN₁), a first gate driving port (DRV₁), a first ground port (GND₁) and a first power port (V_{cc1}). The first voltage sensing port (SEN₁) is directly connected to a drain (D₁) of the first MOSFET 501, the first gate driving port (DRV₁) is directly connected to a gate (G₁) of the first MOSFET 501 and the first ground port (GND₁) is directly connected to a source (S₁) of the first MOSFET 501 which is typically further connected to system ground through A(COM).

The second controller 504 of the second pair comprises a second voltage sensing port (SEN₂), a second gate driving port (DRV₂), a second ground port (GND₂) and a second power port (V_{cc2}). The second voltage sensing port (SEN₂) is directly connected to a drain (D₂) of the second MOSFET 503, the second gate driving port (DRV₂) is directly connected to a gate (G₂) of the second MOSFET 503 and the second ground port (GND₂) is directly connected to a source (S₂) of the second MOSFET 503 which is typically further connected to system ground through A(COM).

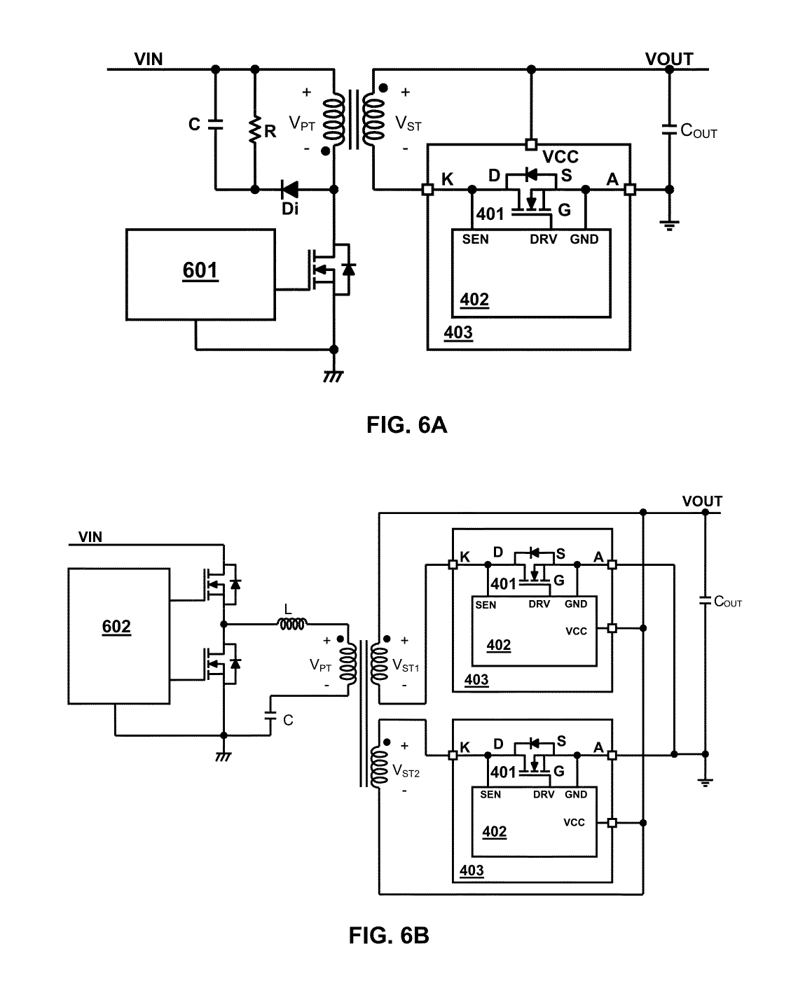

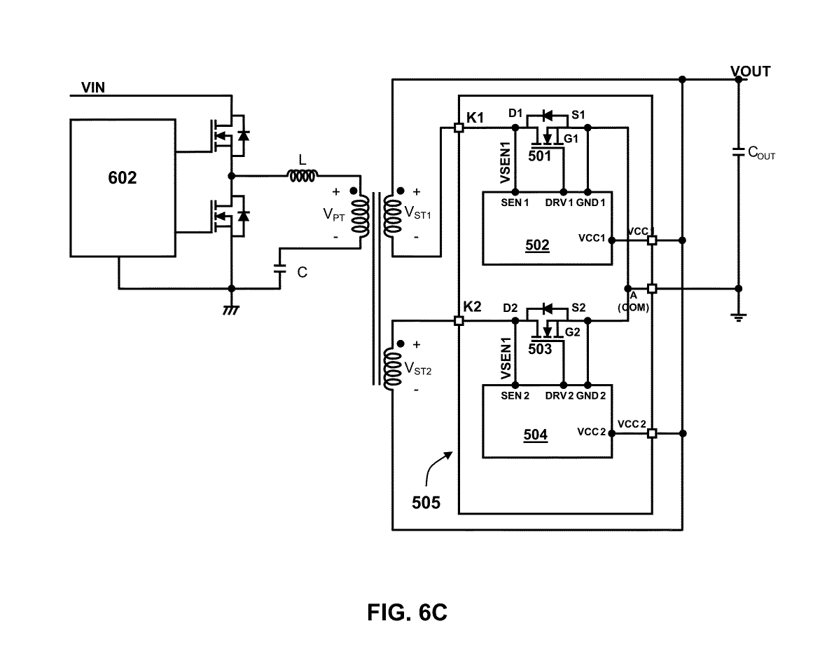

Referring to FIGS. 6A-6B, one synchronous rectifier of FIG. 4 used in an SMPS having a flyback converter 601 configuration and two synchronous rectifiers of FIG. 4 used in an SMPS having a LLC resonant converter 602 configuration are illustrated respectively. As shown in FIG. 6B of the SMPS having a LLC resonant converter, two synchronous rectifiers 403 of FIG. 4 are needed. Alternately, a two channel synchronous rectifier 505 of FIG. 5 can be used with the SMPS having LLC resonant converter 602 as shown in FIG. 6C. The higher level of DC input voltage (Vᵢₙ) in the primary side is converted into lower level of DC by a transformer and further rectified by the synchronous rectifier/s packaged in a single package, or two single packages in case of the pair of the synchronous rectifier of FIG. 4 being used, in the secondary side to provide a clean, regulated DC output (Vₒᵤₜ).

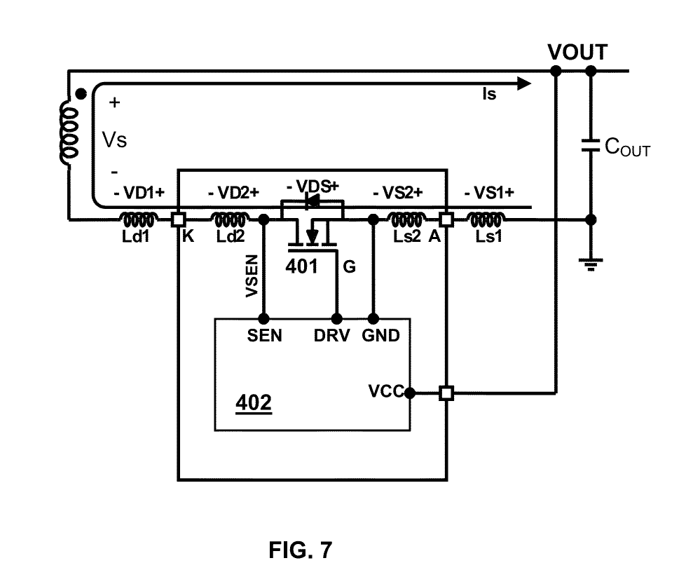

Referring to FIG. 7, the alleviation of the effect of parasitic inductances achieved by the synchronous rectifier of the present disclosure is illustrated. The controller 402 senses voltage (V_{SEN}) through the voltage sensing port (SEN) connected directly to the drain (D) of the MOSFET 401, while the ground reference is available to the controller 402 through the ground port (GND) connected directly to the source (S) of the MOSFET 401. Thus, the packaging of the MOSFET 401 and the controller 402 together in a single package provides shortest path of connection between the ports of the controller 402 and the MOSFET 401 enabling the controller 402 to sense the drain (D) and source (S) of the MOSFET 401 and thereby sense pure drain-to-source voltage across the MOSFET 401 without the effect of parasitic inductances, resulting in accurate sensing of the voltage (V_{SEN}) which can be represented as:

V_{SEN}=−V_{DS}.

The accurately sensed voltage (V_{SEN}) causes the controller 402 to turn OFF the MOSFET 401 at the precise moment resulting in increased ON time of the MOSFET 401. The enhanced ON time of the MOSFET 401 reduces average drop-out voltage of the MOSFET 401, resulting in improved power consumption and better efficiency.

Similarly, the first controller 502 senses voltage (V_{SEN1}) through the first voltage sensing port (SEN₁) connected directly to the drain (D₁) of the first MOSFET 501, while the ground reference is available to the first controller 502 through the first ground port (GND₁) connected directly to the source (S₁) of the first MOSFET 501; and the second controller 504 senses voltage (V_{SEN2}) through the second voltage sensing port (SEN₂) connected directly to the drain terminal (D₂) of the second MOSFET 503, while the ground reference is available to the second controller 504 the second ground port (GND₂) connected directly to the source (S₂) of the second MOSFET 503.

Thus, the packaging of the first and second MOSFETs 501 and 503 and the first and second controllers 502 and 504 together in a single package provides shortest path of connection between the ports of the first and second controllers 502 and 504 and the first and second MOSFETs 501 and 503 respectively, enabling the controllers 502 and 504 to sense the drain (D) and source (S) of the MOSFETs 501 and 503 respectively and thereby sense pure drain-to-source voltage across the MOSFETs 501 and 503 without the effect of parasitic inductances, resulting in accurate sensing of the voltages (V_{SEN1}, V_{SEN2}). The accurately sensed voltages (V_{SEN1}, V_{SEN2}) cause the controllers 502 and 504 to turn OFF the MOSFETs 501 and 503 at the precise moment resulting in increased ON time of the MOSFETs 501 and 503. The increased ON time of the MOSFETs 501 and 503 reduces average drop-out voltage of the MOSFETs 501 and 503, resulting in improved power consumption and better efficiency.

Referring to FIGS. 8A-8B, waveforms depicting the rectification achieved by the synchronous rectifier used in the SMPS having flyback converter configuration of FIG. 6A are illustrated. FIGS. 8A-8B illustrate the current (I_{S}) waveforms in the secondary side of the flyback converter. When the sensed voltage (V_{SEN}) reaches a second threshold voltage Vₜₕ₂, the controller 402 turns OFF the MOSFET 401. The direct connection of the voltage sensing port (SEN) of the controller 402 to the drain (D) of the MOSFET 401 ensures that the effect of parasitic voltage drop (V_{off}) is eliminated, causing the voltage (V_{SEN}) to be accurately sensed. As illustrated in FIGS. 8A-8B, unlike the conventional synchronous rectifier that follow the dashed line the sensed voltage (V_{SEN}) follows the solid line representing the increased turn ON time by inclusion of t_{ON}_{_{—}}_{inc}, thereby causing the controller 402 to turn OFF the MOSFET 401 at the precise time, resulting in improved power consumption and better efficiency.

Referring to FIGS. 8C-8D, waveforms depicting the rectification achieved by the synchronous rectifier used in the SMPS having LLC resonant converter configuration of FIG. 6B are illustrated. FIGS. 8C-8D illustrate the current (I_{S}) waveforms in the secondary side of the LLC resonant converter. When the sensed voltages (V_{SEN1}, V_{SEN2}) reach a second threshold voltage Vₜₕ₂, the controller 502 and 504 turn OFF the MOSFET 501 and 503 respectively. The direct connection of the first voltage sensing ports (SEN₁) of the first controller 502 to the drain (D₁) of the first MOSFET 501 and the direct connection of the second voltage sensing ports (SEN₂) of the second controller (504) to the drain (D₂) of the second MOSFET 503 ensures that the effect of parasitic voltage drop (V_{off}) is eliminated, causing the voltage (V_{SEN1}, V_{SEN2}) to be accurately sensed. As illustrated in FIGS. 8C-8D, unlike the conventional synchronous rectifiers that follow the dashed line the sensed voltages (V_{SEN1}, V_{SEN2}) follow the solid line representing the increased turn ON time by inclusion of t_{ON}_{_{—}}_{inc}, thereby causing the controllers 502 and 504 to turn OFF the MOSFETs 501 and 503 respectively at the precise time, resulting in improved power consumption and better efficiency.

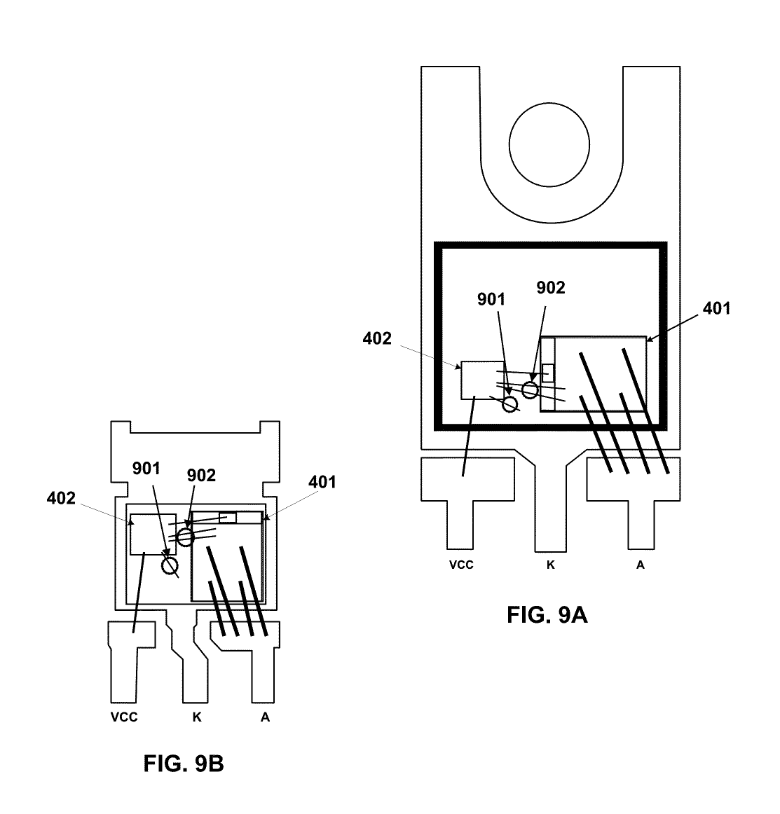

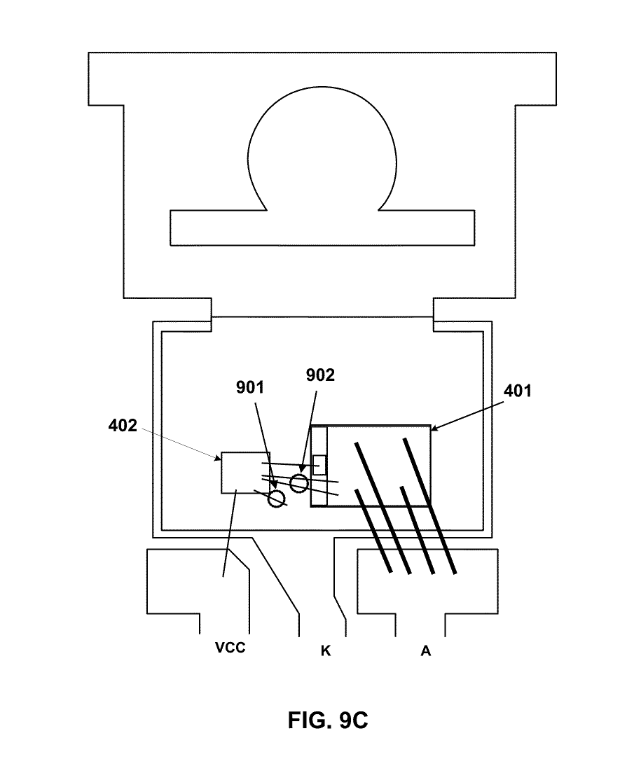

Referring to FIGS. 9A-9C bonding diagrams of the synchronous rectifier of FIG. 4 fabricated in TO220, TO220F, TO252(DPAK) and TO263(D2PAK) semiconductor packages. The semiconductor packages comprise a lead frame having a common die pad within the package and external power lead (V_{cc}), external middle lead (K) and external ground lead (A), wherein the middle lead (K) is connected to the common die pad within the package. The MOSFET 401 has bottom drain (D), top source (S) and top gate (G). The bottom drain (D) is soldered on the common die pad and the voltage sensing port (SEN) of the controller 402 is connected to the common die pad by a down bond or to the bottom drain (D) of MOSFET 401 by a bonding wire thereby providing a shortest drain sensing path (901) for sensing voltage (V_{SEN}) at the drain (D) of the MOSFET 401. Alternately, the voltage sensing port (SEN) of the controller 402 may be connected to the middle lead (K) of the package by a bonding wire. The gate (G) of the MOSFET 401 is connected to the gate driving port (DRV) of the controller 402 by at least one bonding wire. The source (S) of the MOSFET 401 is connected to the ground port (GND) of the controller 402 by a plurality of bonding wires thereby providing a shortest source sensing path 902. Further, the source (S) of the MOSFET 401 is connected to the ground lead by a plurality of bonding wires. The controller 402 is attached to the common die pad using a layer of non-conductive material to electrically isolate the controller 402 from the common die pad. An additional layer of non-conductive material is coated on the side of the controller 402 attached to the common die pad. The lead frame is partially plated with silver or nickel to have better wire bondability. Typically, the external power lead (V_{cc}) is plated with silver and the external ground lead (A) is plated with nickel.

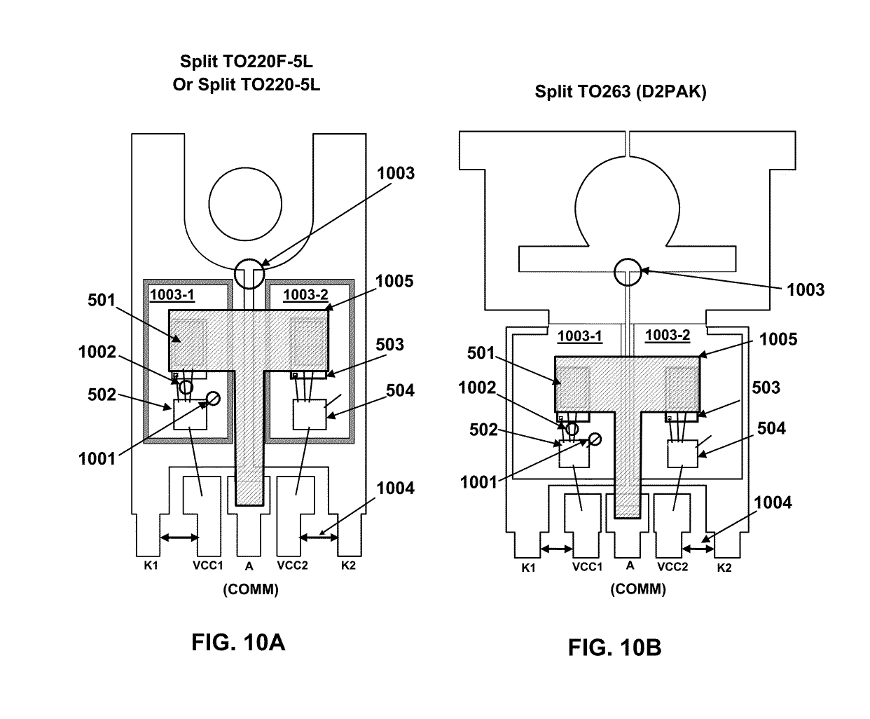

Referring to FIGS. 10A-10B, bonding diagrams of the synchronous rectifier of FIG. 5 fabricated in TO220, TO220F and TO263(D2PAK) semiconductor packages is illustrated. The semiconductor packages comprise a split lead frame 1003 having a split die pad comprising a first die pad 1003-1 and a second die pad 1003-2 within the package and external first power lead (V_{cc1}), external second power lead (V_{cc2}), external first sensing lead (K₁), external second sensing lead (K₂), and external common ground lead (A_{COMM}), wherein the first sensing lead (K₁) is connected to the first die pad and the second sensing lead (K₂) is connected to the second die pad within the package. The space between two leads has wide pitch 1004. Each of the first and second MOSFETs 501 and 503 has bottom drain (D₁, D₂), top source (S₁, S₂) and top gate (G₁, G₂). The bottom drain (D₁) of the first MOSFET 501 is soldered on the first die pad and the first voltage sensing port (SEN₁) of the first controller 502 is connected to the first die pad by a down bond or to the bottom drain (D₁) of the first MOSFET 501 by a bonding wire thereby providing a shortest drain sensing path 1001 for sensing voltage (V_{SEN1}) at the drain (D₁) of the first MOSFET 501. Alternately, the first voltage sensing port (SEN₁) of the first controller 502 may be connected to the first sensing lead (K₁) of the package by a bonding wire. The bottom drain (D₂) of the second MOSFET 503 is soldered on the second die pad and the second voltage sensing port (SEN₂) of the second controller 504 is connected to the second die pad by a down bond or to the bottom drain (D₂) of the second MOSFET 503 by a bonding wire thereby providing a shortest drain sensing path (1001) for sensing voltage (V_{SEN2}) at the drain (D₂) of the second MOSFET 503. Alternately, the second voltage sensing port (SEN₂) of the second controller 504 may be connected to the second sensing lead (K₂) of the package by a bonding wire. The gate (G₁) of the first MOSFET 501 is connected to the first gate driving port (DRV₁) of the first controller 502 by at least one bonding wire, and the gate (G₂) of the second MOSFET 503 is connected to the second gate driving port (DRV₂) of the second controller 504 by at least one bonding wire. The source (S₁) of the first MOSFET 501 is connected to the first ground port (GND₁) of the first controller 502 by a plurality of bonding wires thereby providing a shortest source sensing path 1002. Further, the source (S₁) of the first MOSFET 501 is connected to the common ground lead (A_{COMM}) by a plurality of bonding wires. The source (S₂) of the second MOSFET 503 is connected to the second ground port (GND₂) of the second controller 504 by a plurality of bonding wires thereby providing a shortest source sensing path 1002. Further, the source (S₂) of the second MOSFET 503 is connected to the common ground lead (A_{COMM}) by a metal clip 1005 or a plurality of bonding wires. The first controller 502 is attached to the first die pad using a layer of non-conductive material to electrically isolate the first controller 502 from the first die pad, and the second controller 504 is attached to the second die pad using a layer of non-conductive material to electrically isolate the second controller 504 from the second die pad. An additional layer of non-conductive material is coated on the side of each controller 502 and 504 attached to the first and second die pad respectively. The lead frame is partially plated with silver or nickel to have better wire bondability. Typically, the first and second external power lead (V_{cc1}, V_{cc2}) are plated with silver and the external common ground lead (A_{COMM}) is plated with nickel.

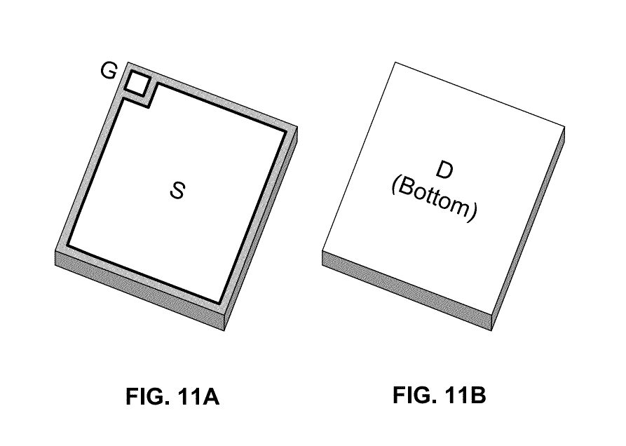

Referring to FIGS. 11A-11B, a conventional MOSFET configuration is illustrated. The conventional MOSFET has Drain (D) at the bottom side, and Source (S) and Gate (G) at the top side of a silicon die of the MOSFET. The bottom Drain (D) is typically connected to the common die paddle of a package lead frame using conductive adhesive material. As mentioned herein above, the synchronous rectifier of FIG. 4 includes MOSFET 401 having top gate (G), top source (S) and bottom drain (D) which is soldered on the common die pad, and controller 402 having its voltage sensing port (SEN) connected to the common die pad by a down bond. Similarly the synchronous rectifier of FIG. 5 includes first and second MOSFETs 501 and 503 having top gates (G₁, G₂), top sources (S₁, S₂) and bottom drains (D₁, D₂) which are soldered on the first die pad and the second die pad respectively; and first and second controllers 502 and 504 having first voltage sensing port (SEN₁) connected to the first die pad and second voltage sensing port (SEN₂) connected to the second die pad respectively by down bonds. The MOSFET 401 and the MOSFETs 501 and 503 comprise conventional MOSFET configurations. A drawback of using the conventional MOSFET in semiconductor packages of the synchronous rectifiers of FIGS. 4 and 5 is that the down bonding is severely affected if the semiconductor package is delaminated. Delamination causes bonding wire searing, ball lift, cracking, and the like resulting in severe damage to the rectifiers.

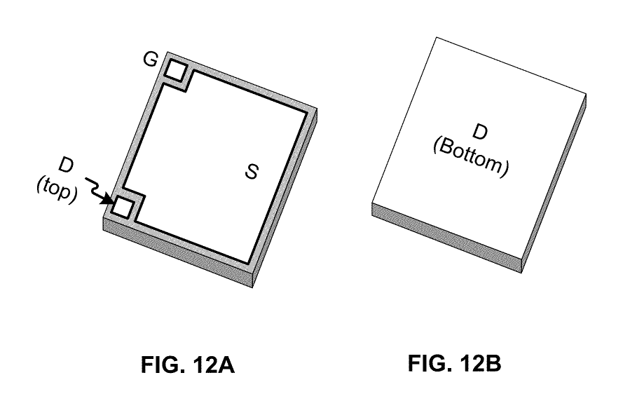

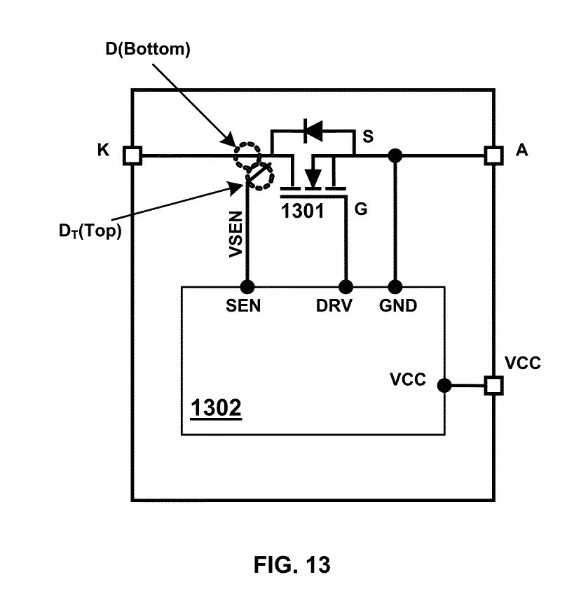

Referring to FIGS. 12A-12B, a dual drain MOSFET configuration in accordance with an embodiment of the present disclosure is illustrated. The dual drain MOSFET is designed to alleviate the drawback associated with delamination in conventional MOSFETs. The dual drain MOSFET comprises top gate (G), top source (S), bottom drain (D) and an additional top drain pad (D_{T}). The additional top drain (D_{T}) is electrically connected to the bottom drain (D) within a silicon die of the dual drain MOSFET and has the same voltage level as the bottom drain (D).

Referring to FIG. 13, a synchronous rectifier in accordance with another embodiment of the present disclosure is illustrated. The rectifier comprises a discrete switching device 1301 and a controller 1302 packaged in a single semiconductor package. The drain terminal of the package is denoted by K (Cathode), the source terminal of the package is denoted by A (Anode) and the power supply terminal of the package is denoted by V_{cc} which supplies power to the controller 1302. The controller 1302 comprises a voltage sensing port (SEN), a gate driving port (DRV), a ground port (GND) and a power port (V_{cc}). The discrete switching device 1301 comprises the dual drain MOSFET configuration illustrated in FIGS. 12A-12B. The controller 1302 senses voltage across the dual drain MOSFET 1301 and enables/disables the dual drain MOSFET 1301 based on the sensed voltage. The voltage sensing port (SEN) is connected directly to the top drain (D_{T}) of the MOSFET 1301, the gate driving port (DRV) is connected directly to a gate (G) of the MOSFET 1301 and the ground port (GND) is connected directly to a source (S) of the MOSFET 1301 which is typically further connected to system ground through A. During the turn ON operation, load current flows from A to K through the source (S), the bottom drain (D) and the additional top drain (D_{T}) of the dual drain MOSFET 1301.

The controller 1302 senses voltage (V_{SEN}) through the voltage sensing port (SEN) connected directly to the top drain (D_{T}) of the dual drain MOSFET 1301, while the ground reference is available to the controller 1302 through the ground port (GND) connected directly to the source (S) of the dual drain MOSFET 1301. Thus, the dual drain MOSFET 1301 and the packaging of the dual drain MOSFET 1301 and the controller 1302 together in a single package provides shortest path of connection between the ports of the controller 1302 and the dual drain MOSFET 1301 enabling the controller 1302 to sense the drain (D_{T}) and source (S) of the dual drain MOSFET 1301 and thereby sense pure drain-to-source voltage across the MOSFET 1301 without the effect of parasitic inductances. The accurately sensed voltage (V_{SEN}) causes the controller 1302 to turn OFF the MOSFET 1301 at the precise moment resulting in increased ON time of the MOSFET 1301.

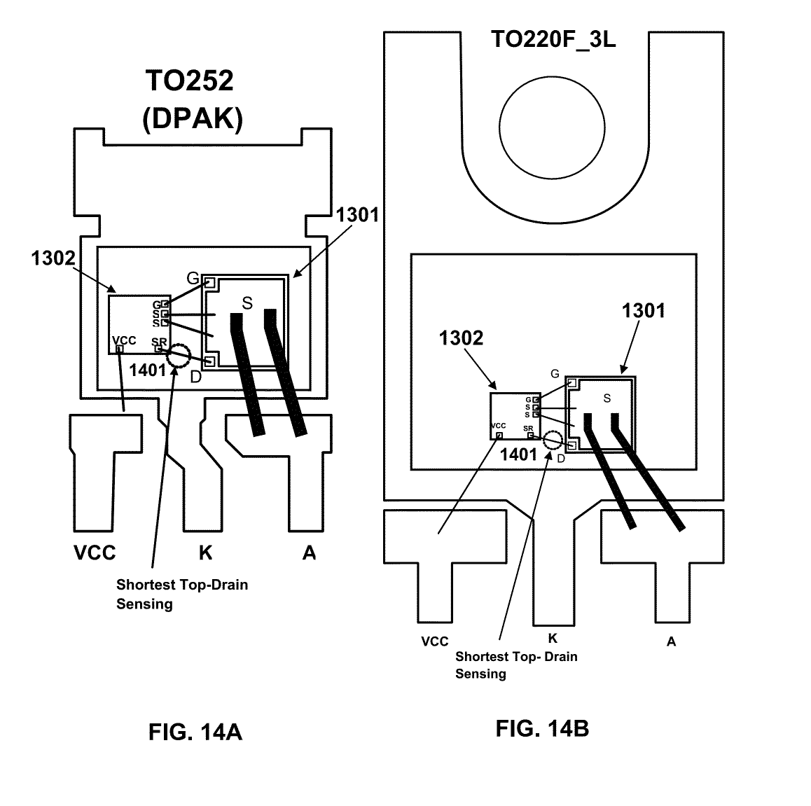

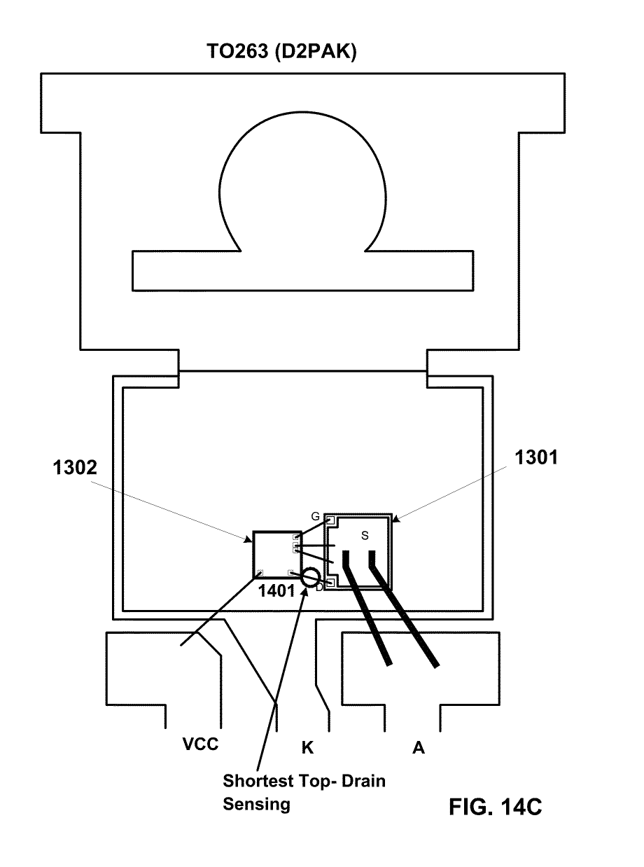

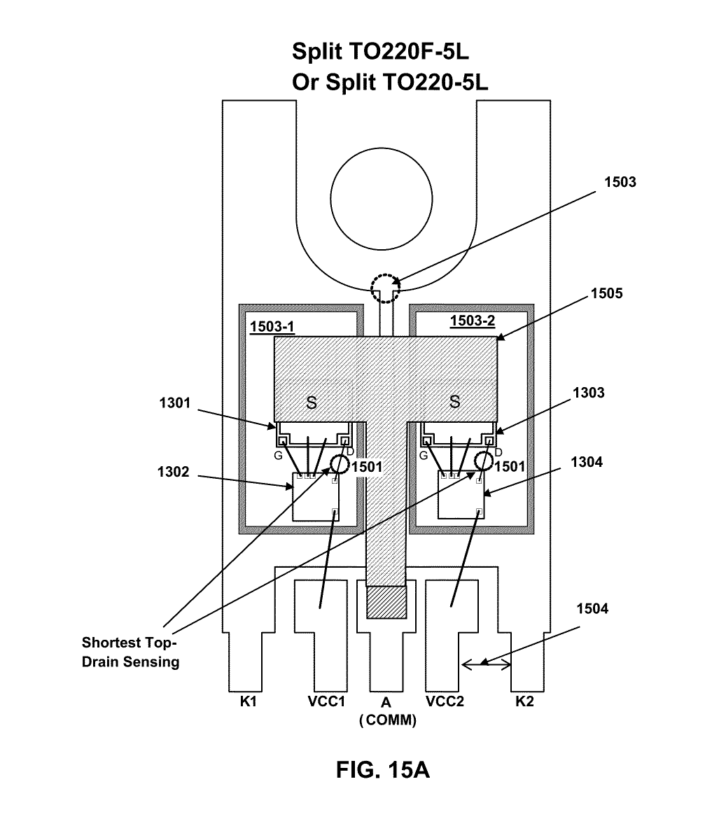

Referring to FIGS. 14A-14C, bonding diagrams of the synchronous rectifier of FIG. 13 fabricated in TO220F, TO252(DPAK) and TO263(D2PAK) semiconductor packages are illustrated. The semiconductor packages comprise a lead frame having a common die pad within the package and external power lead (V_{cc}), external middle lead (K) and external ground lead wherein the middle lead (K) is connected to the common die pad within the package. The MOSFET is the dual drain MOSFET 1301 having bottom drain (D), top source (S), top gate (G) and an additional top drain pad (D_{T}). The bottom drain (D) is soldered on the common die pad and the voltage sensing port (SEN) of the controller 1302 is connected to the additional top drain (D_{T}) of dual drain MOSFET 1301 by a bonding wire thereby providing a shortest drain sensing path (1401) for sensing voltage (V_{SEN}) at the top drain (D_{T}) of the dual drain MOSFET 1301. Alternately, the voltage sensing port (SEN) of the controller 1302 may be connected to the middle lead (K) of the package by a bonding wire. The gate (G) of the dual drain MOSFET 1301 is connected to the gate driving port (DRV) of the controller 1302 by at least one bonding wire. The source (S) of the dual drain MOSFET 1301 is connected to the ground port (GND) of the controller 1302 by a plurality of bonding wires thereby providing a shortest source sensing path. Further, the source (S) of the dual drain MOSFET 1301 is connected to the ground lead (A) by a plurality of bonding wires. The controller 1302 is attached to the common die pad using a layer of non-conductive material to electrically isolate the controller 1302 from the common die pad. An additional layer of non-conductive material is coated on the side of the controller 1302 attached to the common die pad. The lead frame is partially plated with silver or nickel to have better wire bondability. Typically, the external power lead (V_{cc}) is plated with silver and the external ground lead (A) is plated with nickel.

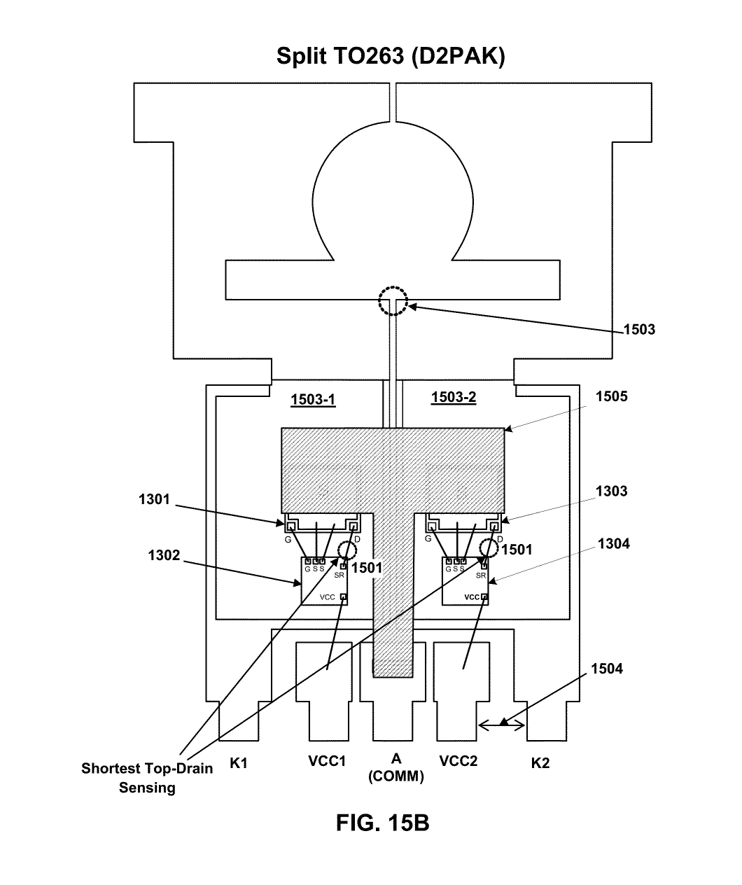

Referring to FIGS. 15A-15B, bonding diagrams of a synchronous rectifier of FIG. 13 having two channels, fabricated in split TO220F and split TO263(D2PAK) semiconductor packages are illustrated. The semiconductor packages comprise a split lead frame 1503 having a split die pad comprising a first die pad 1503-1 and a second die pad 1503-2 within the package and external first power lead (V_{cc1}), external second power lead (V_{cc2}), external first sensing lead (K₁), external second sensing lead (K₂), and external common ground lead (A_{COMM}), wherein the first sensing lead (K₁) is connected to the first die pad and the second sensing lead (K₂) is connected to the second die pad within the package. The space between two leads has wide pitch 1504. The rectifier comprises a first pair of a first discrete switching device 1301 and a first controller 1302 and a second pair of a second discrete switching device 1303 and a second controller 1304 packaged in a single package to provide a two channel synchronous rectifier, wherein the first and second discrete switching devices 1301 and 1303 comprise dual drain MOSFETs. Each of the first and second MOSFETs 1301 and 1303 has bottom drain (D₁, D₂), top source (S₁, S₂) and top gate (G₁, G₂) and additional top drain pad (D_{T1}, D_{T2}) respectively. The bottom drain (D₁) of the first MOSFET 1301 is soldered on the first die pad. The first voltage sensing port (SEN₁) of the first controller 1302 is connected the top drain (D_{T1}) of the first dual drain MOSFET 1301 by a bonding wire thereby providing a shortest drain sensing path for sensing voltage (V_{SEN1}) at the top drain (D_{T1}) of the first MOSFET 1301. Alternately, the first voltage sensing port (SEN₁) of the first controller 1302 may be connected to the first sensing lead (K₁) of the package by a bonding wire. The bottom drain (D₂) of the second MOSFET 1303 is soldered on the second die pad and the second voltage sensing port (SEN₂) of the second controller 1304 is connected to the top drain (D_{T2}) of the second MOSFET 1303 by a bonding wire thereby providing a shortest drain sensing path 1501 for sensing voltage (V_{SEN2}) at the top drain (D_{T2}) of the second MOSFET 1303. Alternately, the second voltage sensing port (SEN₂) of the second controller 1304 may be connected to the second sensing lead (K₂) of the package by a bonding wire. The gate (G₁) of the first dual drain MOSFET 1301 is connected to the first gate driving port (DRV₁) of the first controller 1302 by at least one bonding wire, and the gate (G₂) of the second dual drain MOSFET 1303 is connected to the second gate driving port (DRV₂) of the second controller 1304 by at least one bonding wire. The source (S₁) of the first dual drain MOSFET 1301 is connected to the first ground port (GND₁) of the first controller 1302 by a plurality of bonding wires thereby providing a shortest source sensing path. Further, the source (S₁) of the first dual drain MOSFET 1301 is connected to the common ground lead (A_{COMM}) by a metal clip 1505 or by a plurality of bonding wires (not shown). The source (S₂) of the second dual MOSFET 1303 is connected to the second ground port (GND₂) of the second controller 1304 by a plurality of bonding wires thereby providing a shortest source sensing path. Further, the source (S₂) of the second MOSFET 1303 is connected to the common ground lead (A_{COMM}) by a metal clip 1505 or a plurality of bonding wires (not shown). The first controller 1302 is attached to the first die pad using a layer of non-conductive material to electrically isolate the first controller 1302 from the first die pad, and the second controller 1304 is attached to the second die pad using a layer of non-conductive material to electrically isolate the second controller 1304 from the second die pad. An additional layer of non-conductive material is coated on the side of each controller 1302 and 1304 attached to the first and second die pad respectively. The lead frame is partially plated with silver or nickel to have better wire bondability. Typically, the first and second external power lead (V_{cc1}, V_{cc2}) are plated with silver and the external common ground lead (A_{COMM}) is plated with nickel.

Thus the synchronous rectifier of the present disclosure having the switching device and its controller in a single package, enables accurate sensing of voltage across the switching device thereby reducing power consumption and improving efficiency. Moreover, the single package of the synchronous rectifier reduces the number of external parts and facilitates reduction in the size of heat sink, thereby reducing overall costs. Furthermore, the synchronous rectifier of the present disclosure improves efficiency, thermal performance, power density, manufacturability, and reliability and decreases the overall system cost of power supplies.

### TECHNICAL ADVANTAGES AND ECONOMIC SIGNIFICANCE

The technical advancements offered by the synchronous rectifier of the present disclosure include the realization of:
accurate voltage sensing;
enhanced thermal performance;
increasing efficiency of power supplies;
compact power supply design due to smaller heat sinks and fewer external parts; and
reducing overall costs of power supplies.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

1. A synchronous rectifier comprising at least one discrete switching device and at least one controller adapted to sense voltage across said switching device and enable/disable said switching device based on the sensed voltage, wherein said discrete switching device and said controller are mounted on a common die pad and packaged in a single package and wherein said synchronous rectifier is connected to a secondary side of a transformer in a switched mode power supply (SMPS).

2. The synchronous rectifier of claim 1, wherein said discrete switching device is selected from the group consisting of Bipolar Junction Transistor (BJT), Metal Oxide Semiconductor Field Effect Transistor (MOSFET), Insulated Gate Bipolar Transistor (IGBT) and Silicon Controlled Rectifier (SCR).

3. The synchronous rectifier of claim 2, wherein at least one terminal of said discrete switching device is soldered on said common die pad.

4. The synchronous rectifier of claim 3, wherein said terminal is a bottom drain of a MOSFET, the MOSFET having bottom drain, a top source and a top gate, said bottom drain connected to a secondary side of a transformer in a switched mode power supply (SMPS).

5. The synchronous rectifier of claim 4, wherein said single package comprises a ground lead and the source of said MOSFET is connected to said ground lead by a plurality of bonding wires or a metal clip.

6. The synchronous rectifier of claim 4, wherein said controller comprises a ground port and the source of said MOSFET is connected to said ground port by a plurality of bonding wires.

7. The synchronous rectifier of claim 4, wherein said controller comprises a gate driving port and the gate of said MOSFET is connected to said gate driving port by at least one bonding wire.

8. The synchronous rectifier of claim 7, wherein said controller comprises a voltage sensing port, said voltage sensing port connected to said common die pad by a down bond or to the bottom drain of said MOSFET by a bonding wire.

9. The synchronous rectifier of claim 8, wherein said single package comprises a middle lead connected to said common die pad, said voltage sensing port connected to said middle lead by a bonding wire.

10. The synchronous rectifier of claim 1, wherein said controller is attached to said common die pad using at least one layer of non-conductive material to electrically isolate said controller from said common die pad.

11. The synchronous rectifier of claim 1, wherein said package includes a lead frame having said common die pad, said lead frame partially plated with at least one of silver and nickel.

12. The synchronous rectifier of claim 1, wherein said package is selected from the group consisting of TO220, TO220F, TO252(DPAK) and TO263(D2PAK).

13. The synchronous rectifier of claim 4, wherein the MOSFET is a dual drain MOSFET having a top gate, a top source, a bottom drain and a top drain.

14. The synchronous rectifier of claim, wherein said voltage sensing port is connected to the top drain of said dual drain MOSFET by a bonding wire and said bottom drain of said dual drain is connected to a secondary side of a transformer in a switched mode power supply (SMPS).

15. A two channel synchronous rectifier comprising:
a first pair of a first discrete switching device and a first controller adapted to sense voltage across said first discrete switching device and enable/disable said first discrete switching device based on the sensed voltage across said first discrete switching device;
a second pair of a second discrete switching device and a second controller adapted to sense voltage across said second discrete switching device and enable/disable said second discrete switching device based on the sensed voltage across said second discrete switching device; and
said first pair mounted on a first die pad and said second pair mounted on a second die pad and packaged in a single package, wherein said first and said second die pads are electrically isolated from each other, and wherein said synchronous rectifier is connected to a secondary side of a transformer in a switched mode power supply (SMPS).

16. The synchronous rectifier of claim 15, wherein each of said first discrete switching device and said second discrete switching device is selected from the group consisting of Bipolar Junction Transistor (BJT), Metal Oxide Semiconductor Field Effect Transistor (MOSFET), Insulated Gate Bipolar Transistor (IGBT) and Silicon Controlled Rectifier (SCR).

17. The synchronous rectifier of claim 16, wherein:
at least one terminal of said first discrete switching device is soldered on said first die pad; and
at least one terminal of said second discrete switching device is soldered on said second die pad.

18. The synchronous rectifier of claim 17, wherein:
said terminal of said first switching device is a bottom drain of a first MOSFET; and
said terminal of said second switching device is a bottom drain of a second MOSFET;
each of said first and second MOSFETs having a bottom drain, a top source and a top gate;
wherein said drain of each of said first and second MOSFETs is connected to a secondary side of a transformer in a switched mode power supply (SMPS).

19. The synchronous rectifier of claim 18, wherein said single package comprises a common ground lead and the source of said first MOSFET and the source of said second MOSFET are connected to said common ground lead by a plurality of bonding wires or a metal clip.

20. The synchronous rectifier of in claim 18, wherein:
said first controller comprises a first ground port and the source of said first MOSFET is connected to said first ground port by a plurality of bonding wires; and
said second controller comprises a second ground port the source of said second MOSFET is connected to said second ground port by a plurality of bonding wires.

21. The synchronous rectifier of claim 18, wherein:
said first controller comprises a first gate driving port and the gate of said first MOSFET is connected to said first gate driving port by at least one bonding wire; and
said second controller comprises a second gate driving port and the gate of said second MOSFET is connected to said second gate driving port by at least one bonding wire.

22. The synchronous rectifier of claim 21, wherein:
said first controller comprises a first voltage sensing port, said first voltage sensing port connected to said first die pad by a down bond or to the bottom drain of said first MOSFET by a bonding wire; and
said second controller comprises a second voltage sensing port, said second voltage sensing port connected to said second die pad by a down bond or the bottom drain of said second MOSFET by a bonding wire.

23. The synchronous rectifier of claim 22, wherein:
said single package comprises a first sensing lead connected to said first die pad, said voltage sensing terminal connected to said first sensing lead by a bonding wire; and
said package comprises a second sensing lead connected to said second die pad, said voltage sensing terminal connected to said second sensing lead by a bonding wire.

24. The synchronous rectifier as claimed in claim 15, wherein:
said first controller is attached to said first die pad using at least one layer of non-conductive material to electrically isolate said first controller from said first die pad; and
said second controller is attached to said second die pad using at least one layer of non-conductive material to electrically isolate said second controller from said second die pad.

25. The synchronous rectifier of claim 15, wherein said single package comprises a first lead frame having said first die pad and a second lead frame having said second die pad, said first and second lead frames are electrically isolated from each other, and said first and second lead frames are partially plated with at least one of silver and nickel.

26. The synchronous rectifier of claim 15, wherein said single package is selected from the group consisting of split TO220, split TO220F and split TO263(D2PAK) or from their derivatives.

27. The synchronous rectifier of claim 18, wherein each of said first and second MOSFETs is a dual drain MOSFET having a top gate, a top source, a bottom drain and a top drain.

28. The synchronous rectifier of claim 27, wherein:
said first voltage sensing port is connected to the top drain of said first dual drain MOSFET by a bonding wire; and
said second voltage sensing port is connected to the top drain of said second dual drain MOSFET by a bonding wire.
